(19) United States
(12) Patent Application Publication
(10) Pub. No.: US 2023/0385101 A1
(43) Pub. Date: Nov. 30, 2023

(54) POLICY-BASED DEPLOYMENT WITH SCOPING AND VALIDATION

(71) Applicant: Microsoft Technology Licensing, LLC, Redmond, WA (US)

(72) Inventors: Nidhi VERMA, Bellevue, WA (US); Rahul NIGAM, Bothell, WA (US); Chandramouleeswaran KRISHNASWAMY, Seattle, WA (US)

(73) Assignee: Microsoft Technology Licensing, LLC, Redmond, WA (US)

(21) Appl. No.: 17/828,721

(22) Filed: May 31, 2022

(51) Int. Cl. G06F 9/48; G06F 9/50; G06F 21/44

(52) U.S. Cl. CPC G06F 9/4881; G06F 9/5072; G06F 21/44; G06F 2209/5021

(57) ABSTRACT

Systems and methods for creating and deploying jobs in a cloud-based service include receiving a job definition defining job attributes pertaining to a job to be deployed in a cloud-based service. The job definition is processed to determine whether the job definition complies with predefined rules for job creation in the cloud-based service. Based on the determination of whether the job definition complies with the predefined rules for job creation in the cloud-based server, the job may be validated or not validated in the cloud-based service. Deployment policies are determined for validated jobs based on the job definition for the validated job.

### BACKGROUND

Cloud-based services provide computing services over the Internet or a dedicated network. The cloud-based services may provide computing resources, analytics, storage, and network resources to customers. These services may include, but are not limited to applications for creating, consuming, and/or modifying content, file storage and management platforms, collaboration and communications platforms, and other types of software as a service. The architecture of a typical cloud-based service includes numerous servers, network devices, and storage elements to support the services provided. These devices include software, data, and configuration files that need to be periodically updated to add new features, to roll out fixes to software and/or configuration. Furthermore, some services may support software installed on the client devices, and this software may also need to be updated to a newer version to support added features and/or to fix problems associated with a current version of the software.

Updates are typically rolled out in multiple stages to different groups of devices and/or users to mitigate the risk of deploying the new version of the software and/or configuration data. This approach is referred to as ring deployment. The deployment process is represented by an expanding series of rings, where each ring includes deploying the update to a larger subset of the userbase being provided access to the update. The underlying hardware and software that support the subset of the userbase associated with the ring is updated. User feedback and telemetry data may be collected from users associated with each ring to determine whether the new version of the software is operating correctly before deploying the updates to the next ring. This process may continue until the update are deployed across the entire userbase.

Rolling out such changes across the various systems of a cloud-based service in stages is often not a straightforward process. The subsystems of the cloud-based service may have different deployment configurations that define how changes are deployed across these subsystems. The rings for deploying the updates across one subsystem may not completely align with the rings for deploying updates across another system of the cloud-service. Consequently, rolling out updates that impact more than one subsystem of the cloud-service may be a time consuming and manual process for deploying updates.

In addition, some updates are riskier by nature, such as updates requiring changes on a large scale, e.g., regional and/or world-wide, as well as updates that must be performed quickly to address a critical issue, such as a service outage. Deployment policies for updates, however, may not adequately take into consideration the scope and/or the risk of the job. Current methods for determining deployment policies may rely on user input to define the parameters for deployment of an update. This can result in errors and/or missing data in the job information which can in turn result in inadequate and/or incorrect deployment policies being put in place for a job.

What is needed are systems and methods for deploying updates that take into consideration the scope and risk of the updates and ensures that any information that is needed to determine the appropriate deployment policy for a job is provided.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of a job creation and deployment system for the cloud-bases service of FIG. 1.

FIG. 3 depicts a diagram of a job definition defining attributes for a job for use with the job creation and deployment system of FIG. 2.

FIG. 4 depicts a diagram of an example ring configuration for deploying updates on a cloud-based service architecture.

FIG. 5 depicts a flowchart of an example method for creating and deploying jobs for a cloud-based service that utilizes build time validation in accordance with this disclosure.

FIG. 6 depicts a flowchart of another example method creating and deploying jobs for a cloud-based service that utilizes build time validation in accordance with this disclosure.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Deployment policies that define the procedures and rules for deploying a job (i.e., an update) may not adequately take into consideration the scope and/or the risk associated with the job. To further complicate things, current methods of defining and creating jobs for deployment provide no safeguards for ensuring that job definitions are complete and/or accurate so that appropriate deployment policies may be implemented for deploying the job.

To address these technical problems and more, in an example, this description provides technical solutions in the form of validation rules defining standards for job creation that may be used in validating jobs at build time to ensure that appropriate deployment policies may be implemented for each job. For example, a rule may be defined requiring one or more attributes of a job, such as scope and risk, to be defined before the job can be created. Rules may also be defined that are attribute-based such that jobs having certain attributes may have additional requirements for job creation. For example, a rule may be defined for jobs having the global scope attribute and/or the high risk attribute such that extra approval, authorization and/or certification of some kind may be required before the job can be created. Finally, rules may also define deployment polices to be implemented based on the attributes of a job. For example, suitable deployment policies may be defined for jobs having a global scope and/or a high risk.

When creating a job, a validation component checks to see if the job information pertaining to the job complies with the validation rules. For example, the validation rules may require that the scope attribute and the risk attribute be defined for each job. If the job information does not define both the scope attribute and the risk attribute of the job, job creation may be denied. The validation component may also be configured to determine whether the job includes any attributes for which other requirements have been stipulated, such as jobs having the global scope attribute and/or the high risk attribute requiring authorization of some form before the job can be created. If a job has the global scope attribute and/or the high risk attribute but does not have the required authorization, job creation may be denied. If the validation component does determine that all the required information for a job has been provided, job creation may be allowed such that deployment policies for the job are created.

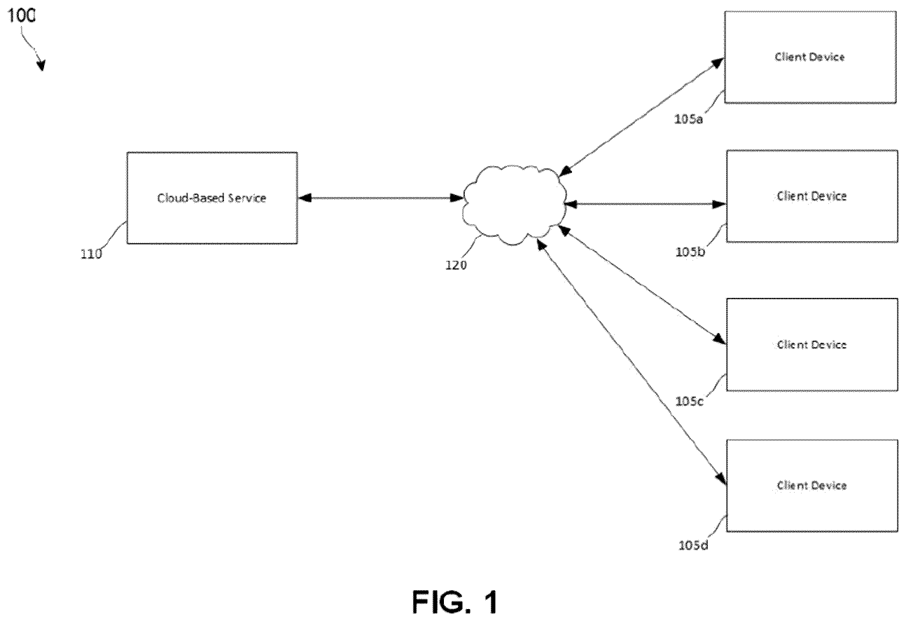

FIG. 1 is a diagram showing an example computing environment 100 in which the techniques for implementing partitioned deployment policies for improved reliability of cloud-based services are provided may be implemented. The computing environment 100 may include a cloud-based service 110 that implements the techniques for executing the deployment policies described herein. The example computing environment 100 may also include one or more client devices, such as the client devices 105a, 105b, 105c, and 105d. The client devices 105a, 105b, 105c, and 105d may communicate with the cloud-based service 110 via the network 120. The network 120 may be a dedicated private network and/or the combination of public and private networks commonly referred to as the Internet.

In the example shown in FIG. 1, the cloud-based service 110 is implemented as a cloud-based service or set of services. These services may include, but are not limited to, applications for creating, consuming, and/or modifying content, file storage and management platforms, collaboration and communications platforms, and other types of software as a service. The cloud-based service 110 may include numerous servers, network devices, storage elements and other components to support the various services that are provided by the cloud-based service 110. For example, the cloud-based service 110 may include one or more collections of computer servers, referred to as a server farm, which are configured to provide computational and/or storage resources for at least a portion of the services provided by the cloud-based service 110. The server farm may be configured to provide fail-over protection so that if a computer server within the server farm experiences a failure, the tasks assigned to that server are handed off to another computer server within the farm.

The client devices 105a, 105b, 105c, and 105d (referred to collectively as client device 105) enable users to access the services provided by the cloud-based service 110. Client devices 105 are computing devices that may be implemented as a portable electronic device, such as a mobile phone, a tablet computer, a laptop computer, a portable digital assistant device, a portable game console, and/or other such devices. The client device 105 may also be implemented in computing devices having other form factors, such as a desktop computer, vehicle onboard computing system, a kiosk, a point-of-sale system, a video game console, and/or other types of computing devices. While the example implementation illustrated in FIG. 1 includes four client devices, other implementations may include a different number of client devices that may utilize the cloud-based service 110. Furthermore, in some implementations, some features of the services provided by the cloud-based service 110 may be implemented by a native application installed on the client device 105, and the native application may communicate with the cloud-based service 110 over a network connection to exchange data with the cloud-based service 110 and/or to access features implemented on the cloud-based service 110.

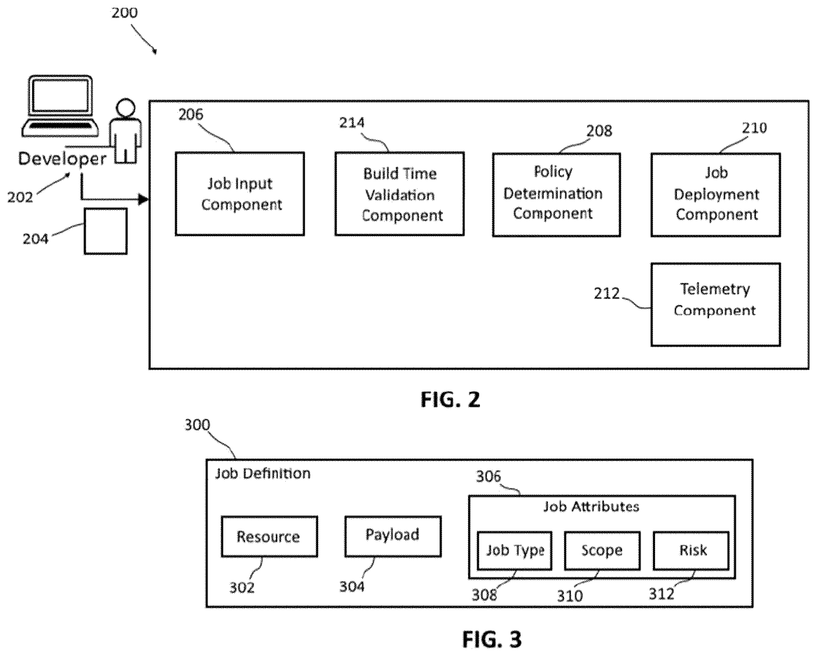

Cloud-based services 110 includes a job creation and deployment system that enables jobs for maintaining application services, updating system infrastructure, updating features, adding new features, addressing issues, and the like to be created and deployed in a safe and reliable manner. An implementation of a job creation and deployment system 200 is shown in FIG. 2. As part of the job creation and deployment system 200, developers 202 develop jobs 204 directed to maintenance (e.g., updating cloud infrastructure or application services), code fixes (e.g., correcting code), code updates (e.g., updating existing features), configurations (e.g., configuring settings or properties), customizations (e.g., enhancements requested by customers), and the like for the cloud-based service 110. The jobs 204 may include programmed instructions, scripts, configuration data, and other content pertaining to the job, referred to herein collectively as “payload” or “job payload.” Job creation and deployment system 200 is configured to receive jobs 204, to determine a deployment policy for each job, and to deploy each job according to its deployment policy. To this end, job creation and deployment system 200 includes a job input component 206, a policy determination component 208, a job deployment component 210.

In response to receiving a request to create a job, job input component 206 is configured to receive a job definition for the job that may be used by the system to create the job and define deployment policies for the job. Job input component 206 may include a user interface that may be presented on the display of a computing device that enables a user, such as administrator or other suitable personnel, to input the job definition. An implementation of a job definition 300 is depicted in FIG. 3. Job definition 300 may identify the resource 302 (e.g., application, service, configuration file, and/or data file) that the job pertains to as well as the payload 304 (e.g., programmed instructions, script(s), configuration data and/or other content) for the job.

Job definition 300 may also include job attribute information 306 pertaining to the job. Job attribute information defines the attributes of the job which may be required and/or useful in determining a deployment policy for the job. In embodiments, job attribute information includes at least job type information 308, scope information 310, and risk information 312. Job type information 308 includes information identifying the type of job, e.g., maintenance type, update type, configuration type, customization type, code fix type, and the like, and/or the type of update to be performed, e.g., read-write, read only, and the like.

The scope information 310 defines a scope for the job. As used herein, a “scope” may refer to any logical division of computing resources within a cloud computing environment, Scopes may indicate the type of device/resource to which the job pertains, e.g. client device, virtual machine, server, farm, database, operating system, and the like, the type of user to which the job pertains, e.g., tenant, customer, internal, manager, regional manager and the like, and/or the geographic range of the job to which the job pertains, e.g., city, state, country, zone, regional, global and the like, to which the job pertains. In embodiments, a plurality of scopes may be predefined for the system such that the user input must for the scope must correspond to at least one of the predefined scopes.

The risk information 312 indicates risk level associated with the job. For example, the risk information may indicate whether the update is low, medium, or high risk. Other implementations may include a numerical rating or other indication that represents a risk level associated with the update. The risk level may be determined based on a potential impact of the job on the customer base. A high-risk update may be associated with features used by many users and may significantly impact the ability of these users to utilize the services provided by the cloud-based service 110 if the updates do not operate as expected. A medium-risk update may impact fewer users than a high-risk update, may impact features that are used by fewer users, and/or may not as severely impact the ability of users to use the services provided by the cloud-based service 110. A low-risk update may impact few users and/or impact features that are infrequently used or would not impact the ability of most users to use the services provided by the cloud-based service 110. As other examples, a read-only update property for a database scope may be associated with low risk, a read-write update property on a tenant scope may be associated with medium risk, and a read-write update property for a multiple-farm scope may be associated with high risk. In embodiments, global scope jobs may automatically be considered high risk jobs regardless of the type of job.

The policy determination component 208 is configured to receive the job definition 300 for a job and to determine one or more deployment policies for deploying the job in the cloud-based service 110. Deployment policies define various parameters for deploying a job, such as timing for deployment, deployment ring configuration, throttling procedure, cool-down periods (i.e., bake times), and the like. In embodiments, different parameters may be defined for different jobs based on the resource 302, payload 304, and/or job attributes 306 (e.g., job type 306, scope 308 and risk 310).

The timing defined for deploying a job may indicate one or more of a start time, an end time, whether the job should be deployed during peak hours or off-peak hours, the order/priority of the job relative to other jobs, and the like. The timing may depend on the attributes of the job. For example, the job type 308 may indicate that the job is for addressing a critical issue in the cloud-based service in which case the job may be given a high priority and/or an earlier start time than other-job types, such as maintenance jobs, customization jobs, jobs for little-used features of the service, and the like.

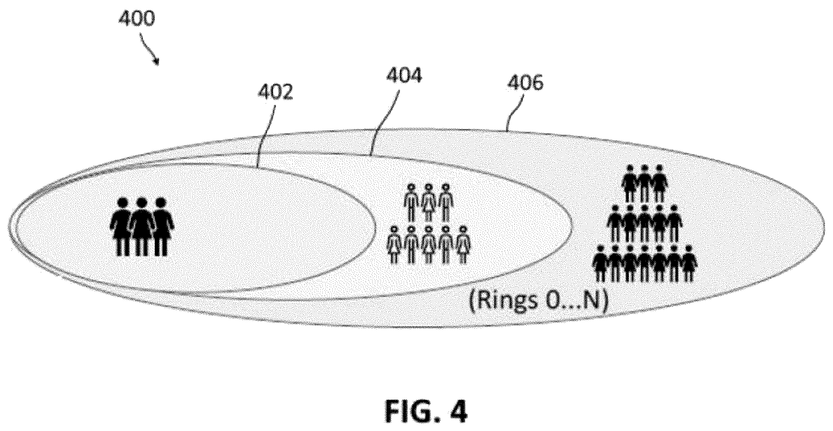

A deployment ring configuration defined for a job refers to the configuration of rings (e.g., number and/or type of rings) used in a ring level validation scheme for rolling out a job. A ring configuration typically includes multiple ring levels of increasing size with each ring level being included in the ring level of the next largest size. Each ring level represents a number of devices and/or users to which the job is to be deployed when deployed to that ring with smaller rings representing lower numbers of devices/users and larger rings representing larger numbers of devices/users. An example of a ring configuration 400 for a job is shown in FIG. 4. The ring configuration 400 includes three rings 402, 404, 406 which correspond to a first ring level 402, a second ring level 404 and a third ring level 406. The first ring level 402 is the smallest ring level and is included in the second ring level 404. The second ring level 404 is the next smallest ring level and is included in the third ring level 406.

According to a ring validation scheme, a job is first deployed to the devices/users in the smallest ring level, e.g., first ring level 402 of the ring configuration 400. The first ring level 402 typically includes a small number of devices/users and may correspond to an internal ring such that the devices/users correspond to developers and/or engineers which can troubleshoot and/or debug the job. The job is then deployed to the second ring level 404 which includes more devices/users than the first ring level 402 and may correspond to another internal ring, a pre-production ring, or a production ring. The job is then deployed to the third ring level 406 which may include even more devices/users and may correspond to a pre-production ring or a production ring. Although three rings 402, 404, 404 are shown in the example of FIG. 4, the number and/or type of rings (e.g., internal, external, pre-production, production) included in a ring configuration associated with a particular deployment may be any suitable number and/or type of ring depending on the job definition 300.

The throttling procedure for a job refers to methods for throttling (i.e., slowing down) deployment of a job within the scope of the job and/or within one or more of the ring levels for the job. For example, a deployment policy for a job may indicate that the job should be throttled by providing the update associated with the job to a first percentage (e.g., 1%) of users/devices within the scope, then a second percentage (e.g., 5%) of users/devices of the scope, then a third percentage (e.g., 10%) of the users/devices within the scope, and so on until 100% of users/devices within the scope have received the update. Different throttling schemes (e.g., percentages and/or increments) may be defined for different jobs depending at least in part on the attributes of the job. In implementations, it may be desirable for jobs having a high risk to have a slower deployment so smaller percentage increment may be used to throttle the deployment. For jobs having a low risk, the throttling scheme may utilize larger percentage increments or may be done away with altogether.

Deployment policies may define the length of cool-down periods, or bake times, to be used during job deployment. A bake-time refers to a period of time after a job has been deployed to a ring stage and/or throttling stage before the job is deployed to the next stage. During the bake-time, telemetry data and/or customer feedback data may be collected from users/devices in each stage and evaluated to determine whether the job should be deployed to the stage or be halted due to problems with the job. Longer bake-times may be defined for high-risk jobs while lower bake-times may be defined for low risk jobs.

Once the one or more deployment policies have been determined for a job, the job deployment unit 210 is configured to deploy the job in accordance with the parameters defined by the one or more deployment policies determined for the job. For example, the job deployment unit 210 may be configured to transmit the payload 304 associated with the job to the users/devices associated with the first ring level 402 of the ring configuration 400 defined for the job based on any timing/priority information defined for the job. Once the bake-time for the job in the first ring level 402 has passed, a determination may be made as to whether the job should be deployed to the next ring level. 404 or halted.

In embodiments, system may include a telemetry component 212 that is configured to receive telemetry data from components of the cloud-based service 110 and/or client devices 105 associated with each ring level of a ring configuration. The telemetry component 212 may be configured to analyze the telemetry data and/or user feedback to determine a performance level of the job within each ring level. Based on the performance level indicated by the telemetry component 212 for each ring level, the job deployment unit 210 may deploy the job to the next ring level or halt the deployment. For example, the job deployment unit 210 may halt the deployment to the subsequent rings of the ring configuration 400 when the performance level of the job indicates the job is not operating as expected. Otherwise, the job deployment unit 210 may deploy the job to the next ring level.

As discussed above, deployment policies that define the procedures and rules for deploying a job (i.e., an update) may not adequately take into consideration the scope and/or the risk associated with the job and known methods of defining and creating jobs for deployment provide no safeguards for ensuring that job definitions are complete and/or accurate so that appropriate deployment policies may be implemented for deploying the job.

To address these issues, the job creation and deployment system 200 is provided with a build time validation component 214 that is configured to process the job definition 300 received by the job input component 206 to determine whether the job definition 300 complies with any predefined rules for the system before the job can be created. In implementations, a rule may be defined for the system requiring one or more attributes of a job to be defined before the job can be created. For example, a rule may require that the scope attribute 310 and the risk attribute 312 be defined for a job before the job can be created. In implementations, rules may be attribute-based such that jobs having certain attributes may have additional requirements for job creation. For example, a rule may be defined for jobs having the global scope attribute and/or the high risk attribute such that authorization of some kind may be required before the job can be created.

If the build time validation component 214 determines that the job definition 300 received by the job input component 206 does not satisfy all predefined rules for job creation, e.g., does not include required attribute information and/or does not indicate that other job creation requirements are met (such as extra approval in the case of global and/or high risk jobs, the build time validation component may reject the request to create the job. In embodiments, build time validation component 214 may be configured to display a warning to a user via the user interface that certain information is required and/or has not been provided. If the build time validation component 214 determines that the job definition received by the job input component 206 satisfies all predefined rules for job creation, build time validation 214 may be configured to provide an indication that the job has been validated so that the job creation process may continue with the policy determination unit 208.

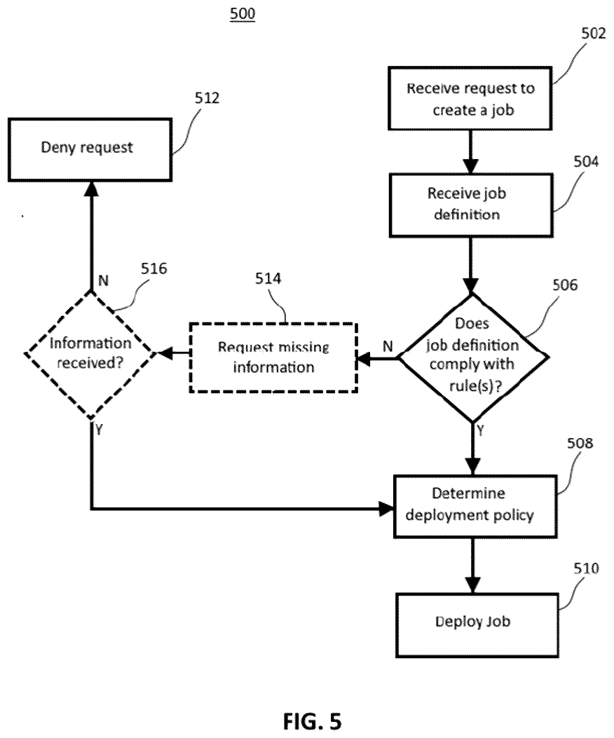

FIG. 5 is a flowchart of an example method 500 for creating and deploying jobs for a cloud-based service that utilizes build time validation in accordance with this disclosure. The method 500 begins with receiving a request to create a job for maintaining, updating, fixing, configuring, and/or customizing one or more services of the cloud-based service (block 502). In addition, a job definition for the job is also received which defines various attributes of the job (block 504). The job definition is then processed to determine whether the job information complies with predefined job creation rules for the cloud-based service (block 506) If the job definition does comply with the predefined rules, the job is considered validated, and the job creation process is allowed to continue with determining one or more deployment policies for the job based on the job definition (block 508) and deploying the job based on the one or more deployment policies for the job (block 510). If the job definition does not comply with the predefined rules, the request to create the job may be denied (block 512). Alternatively, before rejecting the request, further information may be requested to correct the defects associated with the job definition (block 514). If the further information is received (block 516), the job may be considered validated (block 508). If the further information is not received, the request may be denied (block 512).

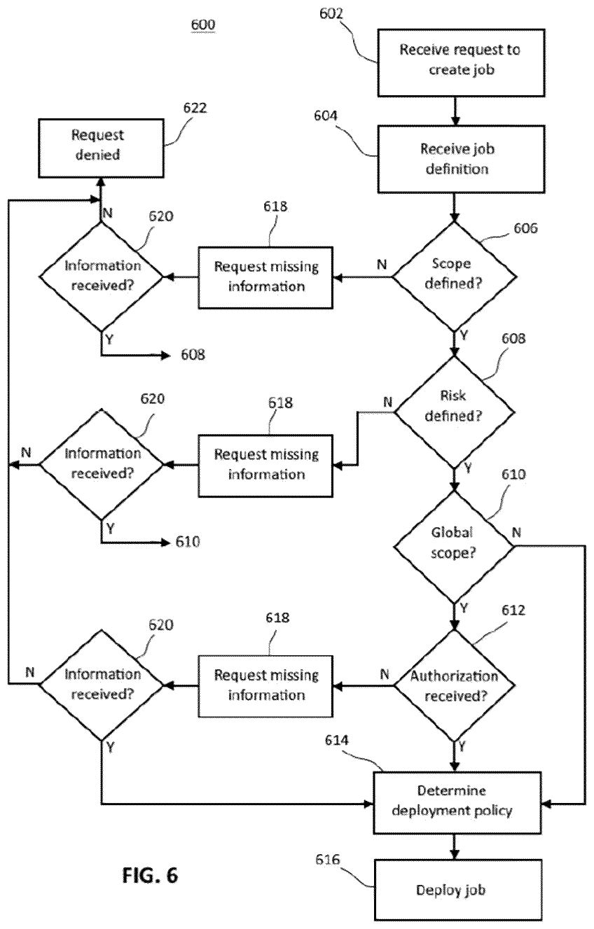

FIG. 6 shows an implementation of a method 600 for creating and deploying jobs for a cloud-based service that utilizes build time validation in accordance with this disclosure. The method 600 begins with receiving a request to create a job (block 602) and receiving the job definition for the job (block 604). The job definition is then processed to determine whether the job information complies with predefined job creation rules for the cloud-based service. For the implementation of FIG. 6, the cloud-based service includes a rule that requires that the job information define the scope attribute and the risk attribute for the job. Accordingly, the job definition is processed to determine whether the job definition includes information defining the scope attribute (block 606) and the risk attribute (block 608) for the job. If the job definition does not define one or both of the scope attribute and the risk attribute for the job, the request may be rejected (block 622). Alternatively, before rejecting the request, the missing information may be requested (block 618), e.g., via the user interface. If the missing information is received (block 620), the method can proceed to the next block, otherwise the job may be rejected (block 622).

If the job definition does have the scope attribute (block 606) and the risk attribute (block 608) defined, the job definition is processed to determine whether it complies with any other requirements for job creation. In this implementation, the cloud-based service also includes a rule requiring some form of authorization to be provided for jobs having a global scope. Accordingly, the job definition is processed to determine whether the job definition indicates that the job has a global scope (block 610). If the job does not have a global scope, the job may then be validated and the job creation process may be allowed to continue with determining one or more deployment policies for the job based on the job definition (block 614) and deploying the job based on the one or more deployment policies for the job (block 616).

If the job does have a global scope (block 610), a determination is then made as to whether the job definition includes the required authorization for the global scope (block 612). If the job definition does include the required authorization, job may then be validated, and the job creation process may be allowed to continue with determining one or more deployment policies for the job based on the job definition (block 614) and deploying the job based on the one or more deployment policies for the job (block 616). If the authorization is not received (block 612), missing information may be requested (block 618). If the missing information is then received (block 620), the job may be validated and deployed (blocks 614, 616). If the missing information is not received, the request may be rejected (block 622).

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7 may be implemented in respective modules, which may also be referred to as, and/or include, logic, components, units, and/or mechanisms. Modules may constitute either software modules (for example, code embodied on a machine-readable medium) or hardware modules.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

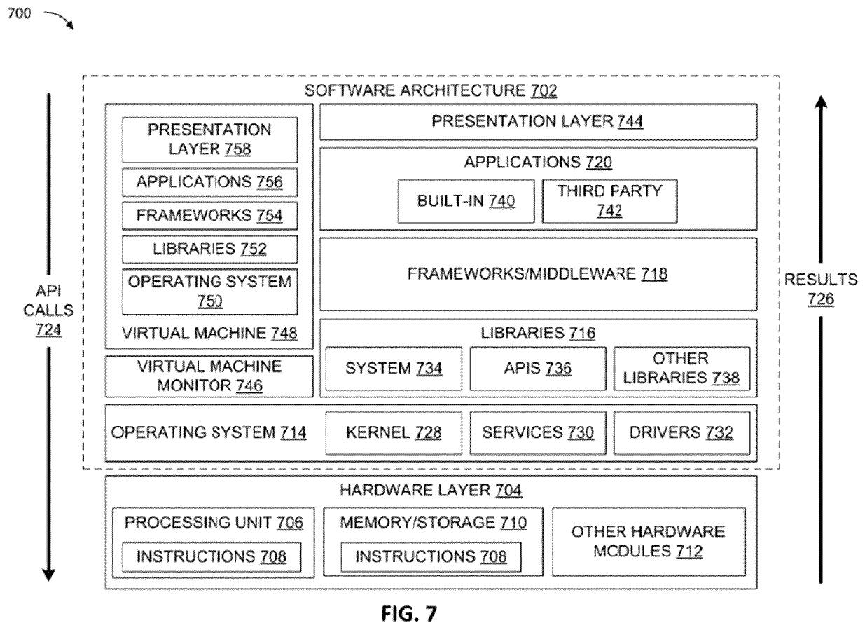

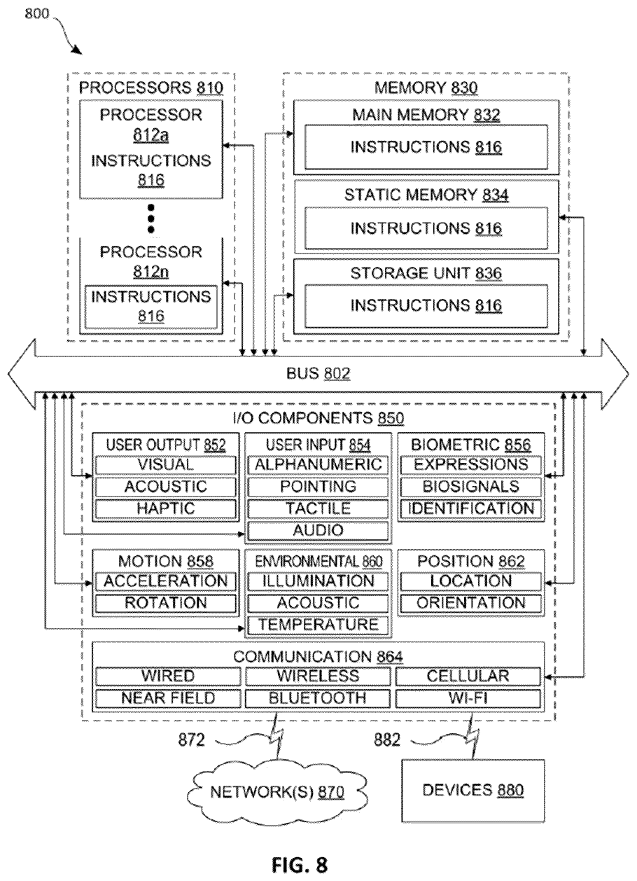

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 1436 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 862, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
at least one processor; and
a machine-readable medium storing executable instructions that, when executed, cause the processor to perform operations comprising:
receiving a job definition defining job attributes pertaining to a job to be deployed in a cloud-based service via a user interface of a job creation and deployment system of the cloud-base service;
determining whether the job definition complies with predefined rules for job creation in the cloud-based service using a validation component of the job creation and deployment system; and
based on the determination of whether the job definition complies with the predefined rules for job creation in the cloud-based service, validating the job or not validating the job for deployment in the cloud-based service using the validation component of the job creation and deployment system.

2. The data processing system of claim 1, further comprising:
determining a deployment policy for each validated job, the deployment policy depending at least in part on the job definition for the validated job; and
deploying the validated job to the cloud-based service based on the deployment policy for the validated job,
wherein deployment policies are not determined for jobs that are not validated.

3. The data processing system of claim 1, wherein the predefined rules include a first rule requiring that one or more job attributes be defined for the job before the job is allowed to be created and deployed, and
wherein the determination of whether the job definition complies with the predefined rules for job creation further comprises:
determining whether the job definition defines the one or more job attributes required by the first rule.

4. The data processing system of claim 3, wherein the one or more attributes include a scope attribute defining a scope of deployment for the job and a risk attribute defining a risk level associated with the job.

5. The data processing system of claim 4, wherein the predefined rules include a second rule requiring that additional information be defined for jobs having one or more predetermined attributes.

6. The data processing system of claim 5, wherein the second rule requires that the additional information includes an authorization for jobs having the scope attribute defined as a global scope and/or the risk attribute defined as a high risk level, and
wherein the determination of whether the job definition complies with the predefined rules for job creation further comprises:
determining whether the job definition defines the scope attribute of the job as a global scope and/or the risk attribute of the job as a high risk level; and
in response to determining that scope attribute of the job is a global scope and/or that the risk attribute of the job is a high risk level, determining whether the job definition includes the authorization required by the second rule.

7. The data processing system of claim 1, wherein jobs having a global scope automatically are assigned a high risk level.

8. A method for creating and deploying jobs in a cloud-based service, the method comprising:
receiving a job definition defining job attributes pertaining to a job to be deployed in a cloud-based service via a user interface of a job creation and deployment system of the cloud-base service;
determining whether the job definition complies with predefined rules for job creation in the cloud-based service using a validation component of the job creation and deployment system; and
based on the determination of whether the job definition complies with the predefined rules for job creation in the cloud-based service, validating the job or not validating the job for deployment in the cloud-based service using the validation component of the job creation and deployment system.

9. The method of claim 8, further comprising:
determining a deployment policy for each validated job, the deployment policy depending at least in part on the job definition for the validated job; and
deploying the validated job to the cloud-based service based on the deployment policy for the validated job,
wherein deployment policies are not determined for jobs that are not validated.

10. The method of claim 8, wherein the predefined rules include a first rule requiring that one or more job attributes be defined for the job before the job is allowed to be created and deployed, and
wherein the determination of whether the job definition complies with the predefined rules for job creation further comprises:
determining whether the job definition defines the one or more job attributes required by the first rule.

11. The method of claim 10, wherein the one or more attributes include a scope attribute defining a scope of deployment for the job and a risk attribute defining a risk level associated with the job.

12. The method of claim 11, wherein the predefined rules include a second rule requiring that additional information be defined for jobs having one or more predetermined attributes.

13. The method of claim 12, wherein the second rule requires that the additional information includes an authorization for jobs having the scope attribute defined as a global scope and/or the risk attribute defined as a high risk level, and
wherein the determination of whether the job definition complies with the predefined rules for job creation further comprises:
determining whether the job definition defines the scope attribute of the job as a global scope and/or the risk attribute of the job as a high risk level; and
in response to determining that scope attribute of the job is a global scope and/or that the risk attribute of the job is a high risk level, determining whether the job definition includes the authorization required by the second rule.

14. The method of claim 8, wherein jobs having a global scope automatically are assigned a high risk level.

15. A non-transitory computer readable medium on which are stored programmed instructions that, when executed, cause a programmable device to perform functions of:
receiving a job definition defining job attributes pertaining to a job to be deployed in a cloud-based service via a user interface of a job creation and deployment system of the cloud-base service;
determining whether the job definition complies with predefined rules for job creation in the cloud-based service using a validation component of the job creation and deployment system; and
based on the determination of whether the job definition complies with the predefined rules for job creation in the cloud-based service, validating the job or not validating the job for deployment in the cloud-based service using the validation component of the job creation and deployment system.

16. The non-transitory computer readable medium of claim 15, wherein the functions further comprise:
determining a deployment policy for each validated job, the deployment policy depending at least in part on the job definition for the validated job; and
deploying the validated job to the cloud-based service based on the deployment policy for the validated job,
wherein deployment policies are not determined for jobs that are not validated.

17. The non-transitory computer readable medium of claim 15, wherein the predefined rules include a first rule requiring that one or more job attributes be defined for the job before the job is allowed to be created and deployed, and
wherein the determination of whether the job definition complies with the predefined rules for job creation further comprises:
determining whether the job definition defines the one or more job attributes required by the first rule.

18. The non-transitory computer readable medium of claim 17, wherein the one or more attributes include a scope attribute defining a scope of deployment for the job and a risk attribute defining a risk level associated with the job.

19. The non-transitory computer readable medium of claim 18, wherein the predefined rules include a second rule requiring that additional information be defined for jobs having one or more predetermined attributes.

20. The non-transitory computer readable medium of claim 19, wherein the second rule requires that the additional information includes an authorization for jobs having the scope attribute defined as a global scope and/or the risk attribute defined as a high risk level, and
wherein the determination of whether the job definition complies with the predefined rules for job creation further comprises:
determining whether the job definition defines the scope attribute of the job as a global scope and/or the risk attribute of the job as a high risk level; and
in response to determining that scope attribute of the job is a global scope and/or that the risk attribute of the job is a high risk level, determining whether the job definition includes the authorization required by the second rule.
